(19) United States
(12) Patent Application Publication
(10) Pub. No.: US 2019/0378393 A1
(43) Pub. Date: Dec. 12, 2019

(54) CONTROL DEVICE, TOILET, INFORMATION PROCESSING DEVICE, STORAGE MEDIUM, AND CONTROL METHOD

(71) Applicant: SHARP KABUSHIKI KAISHA, Sakai City (JP)

(72) Inventor: HIROSHI MATSUURA, Sakai City (JP)

(21) Appl. No.: 16/430,807

(22) Filed: Jun. 4, 2019

(30) Foreign Application Priority Data
Jun. 8, 2018 (JP) 2018-110677

(51) Int. Cl. G08B 21/18; G05B 15/02; G01G 19/52

(52) U.S. Cl. CPC G08B 21/18; G01G 19/52; G05B 15/02

(57) ABSTRACT

Provided are a control device, a toilet, an information processing device, a control program, and a control method, each of which allows a user to be notified of time to replace a consumable item, depending on a weight of the consumable item. The control device controls a pet toilet. The control device includes: a weight obtaining section which obtains information on a weight of a urine sheet which absorbs urine; and a notification processing section which causes a user to be notified of information on time to replace the urine sheet, depending on the weight of the urine sheet.

This Nonprovisional application claims priority under 35 U.S.C. § 119 on Patent Application No. 2018-110677 filed in Japan on Jun. 8, 2018, the entire contents of which are hereby incorporated by reference.

### TECHNICAL FIELD

The present invention relates to (i) a control device which controls an electronic device such as a toilet, an information processing device of a cloud server, or a user terminal, (ii) a toilet, (iii) an information processing device, (iv) a control program, and (v) a control method.

### BACKGROUND ART

In recent years, animal toilets which measure a body weight of a pet or a weight of excreta of a pet have been known. According to this kind of animal toilet, a water-absorbing sheet is, for example, laid, and it is possible to keep the animal toilet clean by replacing the water-absorbing sheet in a case where a pet, for example, urinates.

However, a user sometimes does not notice time to replace the water-absorbing sheet. In such a case, a hygiene problem, such as leakage of urine from the animal toilet, may arise. In order to solve this problem, it is desired that the animal toilet have a function of notifying the user of the time to replace the water-absorbing sheet.

Here, as a notifying technique, Patent Literature 1, for example, discloses a refrigerator having a consumable item replacement requesting function which is a function of (i) accumulating time of use of a consumable item used for the refrigerator and (ii) notifying a user of time to replace the consumable item, in a case where the time of use of the consumable item becomes greater than replacement requesting time. This allows the refrigerator, having the consumable item replacement requesting function, to send a notification to a user by outputting a consumable item replacement requesting signal, and thereby allows the refrigerator to request replacement of a consumable item depending on deterioration of the consumable item.

### CITATION LIST

### Patent Literature

[Patent Literature 1]

Japanese Patent Application Publication, Tokukai, No. 2005-114205

### SUMMARY OF INVENTION

### Technical Problem

By the way, according to the conventional notifying technique disclosed in Patent Literature 1, the time to replace the consumable item is determined in accordance with an accumulated value of the time of use of the consumable item.

However, in a case of the animal toilet, there is a problem that it is not possible to appropriately determine the time to replace the water-absorbing sheet even in a case where an accumulated value of time of use of the water-absorbing sheet is obtained. For example, in a case where the animal toilet makes determination only in accordance with the time of use of the water-absorbing sheet, the animal toilet may notify the user of the time to replace the water-absorbing sheet even in a case where the water-absorbing sheet still has a water-absorbing ability.

An aspect of the present invention has been made in view of the above conventional problem, and an object of the aspect of the present invention is to provide a control device, a toilet, an information processing device, a control program, and a control method, each of which allows a user to be notified of time to replace a consumable item, depending on a weight of the consumable item.

### Solution to Problem

In order to attain the above object, a control device in accordance with an aspect of the present invention is a control device which controls an electronic device, the control device including: a weight obtaining section which obtains information on a weight of a consumable item which absorbs excreta; and
a notification processing section which causes a user to be notified of information on time to replace the consumable item, depending on the weight of the consumable item.

In order to attain the above object, a toilet in accordance with an aspect of the present invention is a toilet including: the above-described control device; and a weight scale which measures the weight of the consumable item.

In order to attain the above object, an information processing device in accordance with an aspect of the present invention is an information processing device including the above-described control device, the weight obtaining section obtaining, from a toilet, the information on the weight of the consumable item.

In order to attain the above object, a control program in accordance with an aspect of the present invention is a control program for causing a computer to function as the above-described control device, the control program causing the computer to function as the weight obtaining section and the notification processing section.

In order to attain the above object, a control method in accordance with an aspect of the present invention is a method for controlling an electronic device, the method including: a weight obtaining step of obtaining information on a weight of a consumable item which absorbs excreta; and a notification processing step of causing a user to be notified of information on time to replace the consumable item, depending on the weight of the consumable item.

### Advantageous Effects of Invention

According to an aspect of the present invention, it is possible to provide a control device, a toilet, an information processing device, a control program, and a control method, each of which allows a user to be notified of time to replace a consumable item, depending on a weight of the consumable item.

### BRIEF DESCRIPTION OF DRAWINGS

FIG. 1 is a block diagram illustrating a configuration of a pet toilet and a configuration of a control device in accordance with Embodiment 1 of the present invention.

FIG. 2A is a perspective view illustrating an external configuration of the pet toilet including the control device. FIG. 2B is an exploded perspective view illustrating the external configuration of the pet toilet.

FIG. 3 is a cross-sectional view illustrating the external configuration of the pet toilet.

FIG. 4 is a flowchart illustrating a flow of control carried out by the control device.

FIG. 5 is a block diagram illustrating a configuration of a pet toilet and a configuration of a control device in accordance with Embodiment 2 of the present invention.

FIG. 6 is a graph showing how, in the pet toilet, time at which it becomes necessary to replace a urine sheet is estimated on the basis of (i) a change in weight of the urine sheet in the past and (ii) the latest weight of the urine sheet.

FIG. 7 is a block diagram illustrating a configuration of a pet toilet and a configuration of a control device in accordance with Embodiment 3 of the present invention, which control device is included in a server group.

### DESCRIPTION OF EMBODIMENTS

### Embodiment 1

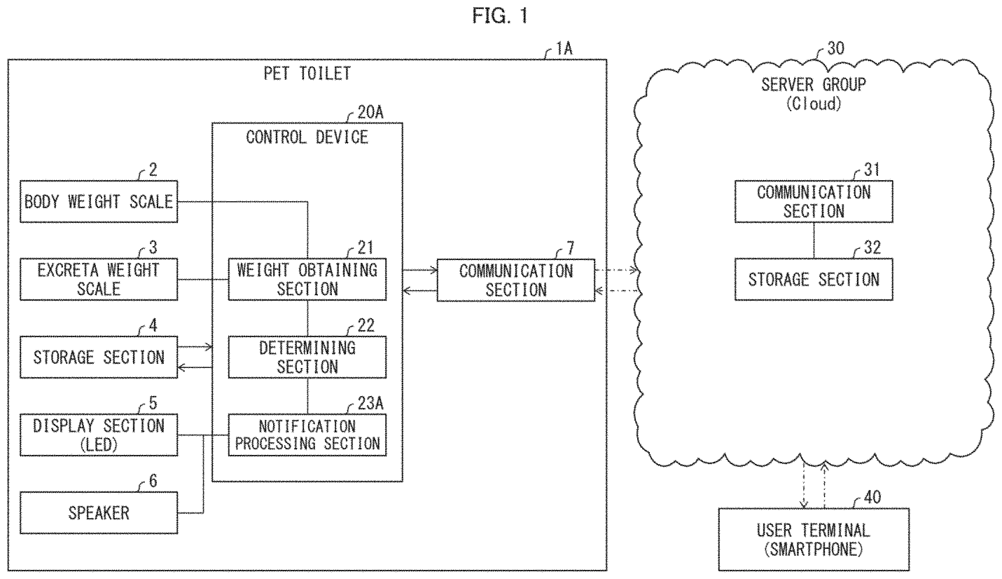

The following description will discuss Embodiment 1 of the present invention with reference to FIGS. 1 through 4.

A pet toilet in accordance with Embodiment 1, which is a toilet and which includes a weight scale, has a function of, for example, (i) measuring a body weight of a pet and (ii) measuring a weight of urine, which is excreta, of the pet. Examples of the pet include animals kept at home, such as cats and dogs. Note, however, that a toilet in accordance with an aspect of the present invention is not necessarily limited to animals such as cats and dogs, and can be applied to the other animals. For example, the toilet in accordance with an aspect of the present invention can be applied to a human.

(Configuration of Pet Toilet)

The pet toilet in accordance with Embodiment 1 has a function of a weight measuring device which measures a body weight of a pet, which is an animal, and a weight of excreta of the pet. In Embodiment 1, the excreta are preferably urine. Therefore, Embodiment 1 will be described based on a premise that the excreta are urine.

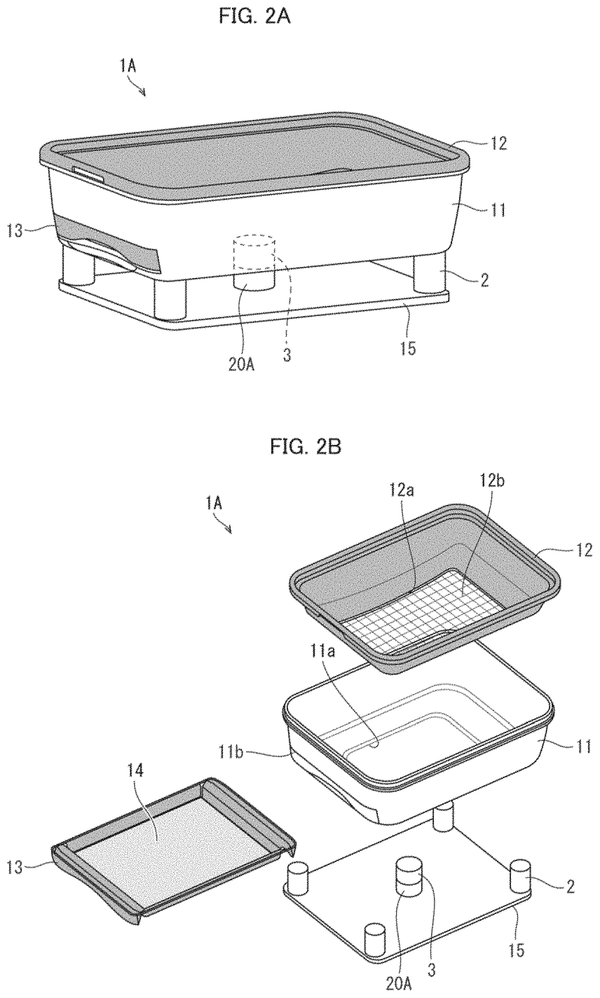

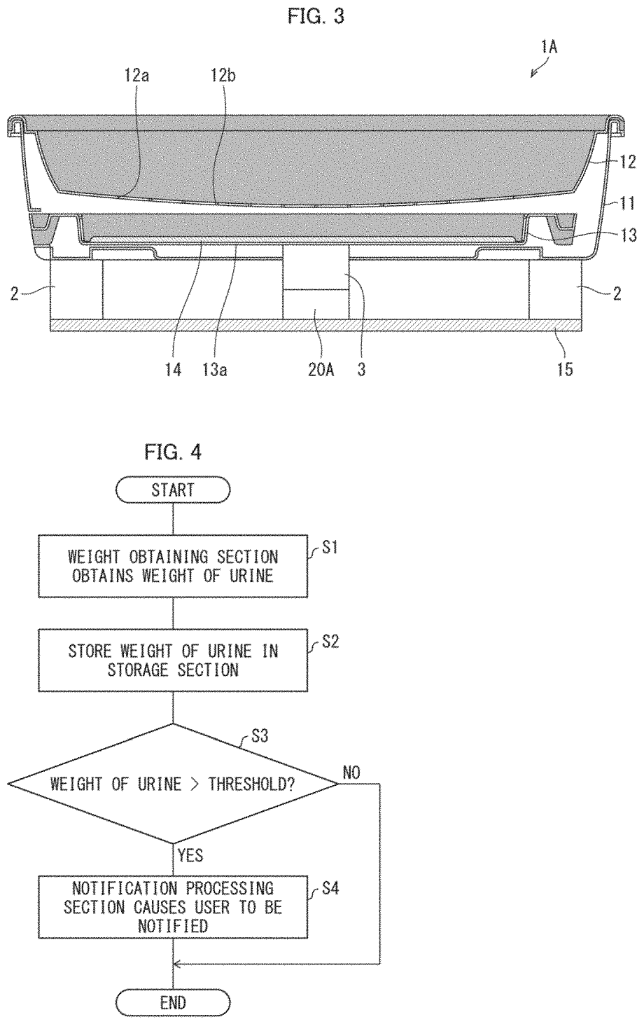

An external configuration of a pet toilet 1A in accordance with Embodiment 1, which is a toilet and which includes a control device, will be described with reference to FIG. 2A, FIG. 2B, arid FIG. 3. FIG. 2A is a perspective view illustrating the external configuration of the pet toilet 1A in accordance with Embodiment 1, which includes a control device 20A. FIG. 2B is an exploded perspective view illustrating the external configuration of the pet toilet 1A. FIG. 3 is a cross-sectional view illustrating the external configuration of the pet toilet 1A.

As illustrated in FIG. 2A, FIG. 2B, and FIG. 3, the pet toilet 1A in accordance with Embodiment 1 includes a main container 11, a measurement stage 12, an excreta tray 13, a urine sheet 14 which is a consumable item, a supporting plate 15, body weight scales 2, an excreta weight scale 3, the control device 20A, and a cover (not illustrated).

The main container 11 has an opening 11a in its middle part, and supports the measurement stage 12. The measurement stage 12 is a stage onto which a pet steps and on which the pet excretes. The measurement stage 12 has an opening 12a in its bottom surface. A mesh 12b is provided to the opening 12a. On the mesh 12b, cat litter or the like can be, for example, put. According to Embodiment 1, the mesh 12b allows a liquid such as urine to pass therethrough, but does not allow, for example, feces and an object (toy), which has been brought by the pet, to pass therethrough. The mesh 12b can be formed from a liquid permeable cloth, a liquid permeable thin film, or the like. The measurement stage 12 can alternatively have, in its bottom surface, a plurality of slits through which excreta pass, instead of the mesh 12b provided to the opening 12a.

According to Embodiment 1, the measurement stage 12 has a shape of a depressed container. However, the measurement stage 12 can have any shape, provided that the measurement stage 12 allows the pet to step onto the measurement stage 12 for measurement of a body weight of the pet.

The excreta tray 13 is disposed between the opening 12a of the measurement stage 12 and the opening 11a of the main container 11, and is a member which receives excreta. The excreta tray 13 can be inserted into and drawn out from a side hole 11b formed in a side surface of the main container 11. Specifically, in a case where the pet urinates on the measurement stage 12, urine passes through the opening 12a to which the mesh 12b is provided, and drops on the urine sheet 14 which is laid on a bottom plate 13a of the excreta tray 13.

The urine sheet 14 is a sheet containing a component which absorbs a liquid such as urine. The urine sheet 14 with respect to which the pet has urinated can be easily replaced with a new one by drawing out the excreta tray 13 from the main container 11.

The supporting plate 15 is a base plate which supports the body weight scales 2, the excreta weight scale 3, and the control device 20A.

According to Embodiment 1, the body weight scales 2 are provided at respective four locations so that the body weight scales 2 support, for example, respective four corners of a rectangular bottom part of the main container 11. The body weight scales 2 include respective load cells (not illustrated), and measure a total weight of the main container 11, in which the measurement stage 12 is disposed, and the pet by the load cells. As a result, it is possible to measure the body weight of the pet by subtracting, as a tare, a weight of the main container 11, in which the measurement stage 12 is disposed, from the total weight. Note that, according to Embodiment 1, since four body weight scales 2 are provided, the body weight of the pet is approximately four times greater than a value measured by each of the body weight scales 2. Those measured values are outputted to a weight obtaining section 21 (later described) of the control device 20A.

The excreta weight scale 3 measures a weight of urine, which is excreta of the pet, by a load cell (not illustrated). According to Embodiment 1, the excreta weight scale 3 is provided in the middle of the supporting plate 15 having a rectangular shape. An upper surface of the excreta weight scale 3 is in contact with the bottom plate 13a of the excreta tray 13. This causes the excreta tray 13, on which the urine sheet 14 is laid, to be supported at a single point. That is, in a case where the excreta tray 13 is inserted in the main container 11, the excreta tray 13 is in contact merely with the upper surface of the excreta weight scale 3 and is not in contact with the main container 11. This makes it possible for the excreta weight scale 3 to measure a weight of the excreta tray 13 on which the urine sheet 14 with respect to which the pet has not urinated yet is laid or the weight of the excreta tray 13 on which the urine sheet 14 with respect to which the pet has urinated is laid. As a result, it is possible to measure a weight of urine, which is excreta of the pet, by subtracting, as a tare, a total value of (i) a weight of the urine sheet 14 with respect to which the pet has not urinated yet and (ii) the weight of the excreta tray 13, from a value measured by the excreta weight scale 3. That is, it is possible to determine a weight of excreta absorbed by the urine sheet 14.

According to Embodiment 1, the control device 20A is provided, for example, under the excreta weight scale 3. That is, the excreta weight scale 3 is provided on the control device 20A. Note, however, that a location at which the control device 20A is provided is not necessarily limited to such a location, and can be alternatively provided at another location.

Note that, according to Embodiment 1, the body weight scales 2 and the excreta weight scale 3 include the respective load cells (not illustrated) each serving as a load sensor. A load cell detects, as a change in voltage, a change in resistance value which change is caused by a strain. Note, however, that, according to an aspect of the present invention, the body weight scales 2 and the excreta weight scale 3 are each not necessarily limited to the load cell, and a weight scale of an electromagnetic force balancing type can be, for example, alternatively used. The weight scale of an electromagnetic force balancing type is configured so as to balance up a balance by an electromagnetic force and detect an electric current at that time.

(Configuration of Control System)

A configuration of a control system of the pet toilet 1A in accordance with Embodiment 1 will be described with reference to FIG. 1. FIG. 1 is a block diagram illustrating the configuration of the control system of the pet toilet 1A in accordance with Embodiment 1.

As illustrated in FIG. 1, the pet toilet 1A in accordance with Embodiment 1 includes, as the control system, the control device 20A, the body weight scales 2, the excreta weight scale 3, a storage section 4, a display section 5, a speaker 6, and a communication section 7.

The body weight scales 2 measure the weight of the main container 11, in which the measurement stage 12 is disposed, or the total weight of the main container 11, in which the measurement stage 12 is disposed, and the pet, and output a measured weight to the weight obtaining section 21 (later described) of the control device 20A.

The excreta weight scale 3 measures (i) the weight of the excreta tray 13 on which the urine sheet 14 is not laid, (ii) the weight of the excreta tray 13 on which the urine sheet 14 that is unused is laid, or (iii) the weight of the excreta tray 13 on which the urine sheet 14 with respect to which the pet has urinated is laid. The excreta weight scale outputs a measured weight to the weight obtaining section 21 of the control device 20A.

According to Embodiment 1, the control device 20A includes the weight obtaining section 21, a determining section 22, and a notification processing section 23A.

The weight obtaining section 21 obtains a value measured by the excreta weight scale 3. Specifically, the excreta weight scale 3 obtains a measured value at a given timing (for example, obtains measured values at regular time intervals). The measured value at this time indicates a total value of the weight of the excreta tray 13 and the weight of the urine sheet 14 which has absorbed urine. Accordingly, the weight obtaining section 21 subtracts, from the measured value, the weight of the excreta tray 13 which weight is stored in the storage section 4 in advance. This makes it possible to obtain, by calculation, the weight of the urine sheet 14 which has absorbed urine. The weight obtaining section 21 outputs, to the determining section 22, the weight of the urine sheet 14 which has absorbed urine.

The determining section 22 determines whether or not the weight of the urine sheet 14, which is a consumable item, is greater than a threshold which is a given value and which is set in advance. The determining section 22 outputs a result of a determination to the notification processing section 23A.

The threshold is set to, for example, a value lower than a sum of (i) the weight of the urine sheet 14 which has not been used and which has not absorbed urine yet and (ii) a weight of urine which the urine sheet 14 can absorb. Note that, according to Embodiment 1, variations in weight between urine sheets 14 which have not been used are small and, therefore, the weight, which has been measured in advance, of the urine sheet 14 which has not been used is stored in the storage section 4 as a set value. Note, however, that the control device 20A is not limited to such a configuration, and can be alternatively configured as follows. That is, when the urine sheet 14 is replaced with another urine sheet 14, a total of (i) the weight of the another urine sheet 14 which has not been used and (ii) the weight of the excreta tray 13 is measured. Each time the total of (i) the weight of the another urine sheet 14 which has not been used and (ii) the weight of the excreta tray 13 is measured, the control device 20A stores the total in the storage section 4.

The threshold can be changed depending on a type of the urine sheet 14. A user can input the threshold in the control device 20A. The control device 20A stores the threshold in the storage section 4. Alternatively, the user can input, in the control device 20A, (i) the weight of the urine sheet 14 which has not been used and (ii) the weight of urine which the urine sheet 14 can absorb. The control device 20A can set, as the threshold, a value obtained by, for example, (i) multiplying, by a coefficient (for example, 80%), the weight of urine which the urine sheet 14 can absorb and (ii) adding, to an obtained value, the weight of the urine sheet 14 which has not been used. The user can input the type of the urine sheet 14 (information by which a product is identified) in the control device 20A. The control device 20A can set the threshold depending on the type of the urine sheet 14. Information depending on the type of the urine sheet 14 (the threshold itself, the weight of the urine sheet 14 which has not been used, and/or the weight of urine which the urine sheet 14 can absorb) can be stored in the storage section 4 in advance or can be alternatively obtained from a server group 30. Alternatively, the user can input the type of the urine sheet 14 in the server group 30 via a user terminal 40. The control device 20A can obtain, from the server group 30, information on the type of the urine sheet 14 and the information depending on the type of the urine sheet 14.

The threshold can be changed depending on the weight of the urine sheet 14 which has not been used. For example, the control device 20A can set, as the threshold, a value obtained by multiplying, by a coefficient (a value higher than 1 (one), for example, 3), the weight of the uric sheet 14 which has not been used. In this manner, the threshold can be set by a rate of increase from the weight, at a time of replacement, of the urine sheet 14 which has not been used. The control device 20A can obtain the weight of the urine sheet 14 which has not been used, at the time of replacement with the urine sheet 14.

The notification processing section 23A causes the user to be notified of information on time to replace the urine sheet 14, depending on the weight of the urine sheet 14. For example, in a case where a measured value of the weight of the urine sheet 14 which contains urine is higher than the threshold, the notification processing section 23A transmits, to the server group 30 via the communication section 7, for example, information indicating that now is time to replace the urine sheet 14, as the information on the time to replace the urine sheet 14. This ultimately causes the user to be notified of the time to replace the urine sheet 14. Specifically, for example, the server group 30 sends a notification to the user terminal 40 such as smartphone.

The notification processing section 23A also causes, for example, the pet toilet 1A itself to notify the user of the time to replace the urine sheet 14 via the display section 5 and the speaker 6. For example, the notification processing section 23A causes (i) the display section 5 to light up an LED (light emitting diode) (not illustrated), (ii) the speaker 6 to ring a buzzer, (iii) the display section 5 to display a message “please replace the urine sheet”, and/or (iv) the speaker 6 to output a voice.

The storage section 4 is constituted by, for example, a flash memory or a hard disk, and stores therein a value which has been measured by the excreta weight scale 3 and which has been obtained by the weight obtaining section 21, the threshold which has been set in advance and which is used by the determining section 22, and the like.

The communication section 7 can communicate with a communication section 31 of the server group 30 of the Internet or can directly communicate with the user terminal 40 such as a smartphone by, for example, near field communication such as Bluetooth (registered trademark).

How the control device 20A having the above configuration carries out control will be described with reference to FIG. 4. FIG. 4 is a flowchart illustrating a flow of control carried out by the control device 20A.

As illustrated in FIG. 4, in a case where the pet steps onto the measurement stage 12 of the pet toilet 1A and urinates, a value measured by the excreta weight scale 3 is inputted to the weight obtaining section 21. The weight obtaining section 21 carries out subtraction of a tare by calculation so as to obtain the weight of the urine sheet 14 which weight includes a weight of urine (S1). The weight of the urine is stored in the storage section 4 (S2). Next, the determining section 22 of the control device 20A. determines whether or not the weight of the urine sheet 14 is greater than the threshold which is set in advance (S3). In other words, the determining section 22 determines whether or not the weight of the urine is greater than a threshold of urine. In a case where the determining section 22 determines that the weight of the urine sheet 14 is greater than the threshold which is set in advance, the determining section 22 outputs, to the notification processing section 23A, a determination that the weight of the urine sheet 14 is greater than the threshold. The notification processing section 23A of the control device 20A causes the display section 5 to, for example, light up the LED or display, on a display screen, a message to replace the urine sheet 14. The notification processing section 23A also causes the speaker 6 to ring a buzzer or notify, by a sound, the user of a message to, for example, replace the urine sheet 14 (S4). This notification means information on time to replace the urine sheet 14. Note that in a case where, in S3, the determining section 22 determines that the weight of the urine is equal to or smaller than the threshold which is set in advance, a process is ended.

Such notifications from the display section 5 and the speaker 6 allow the user to replace the urine sheet 14 with another urine sheet 14, in a case where the user is near the pet toilet 1A.

Note that there is a case where the user stays, for example, outdoors. For such a case, the pet toilet 1A in accordance with Embodiment 1 is configured such that a notification that it is time to replace the urine sheet 14 is communicated from the notification processing section 23A to the server group 30 via the communication section 7. As a result, in the server group 30, the communication section 31 of the server group 30 (i) receives a communication from the communication section 7 of the pet toilet 1A, (ii) stores contents of the communication thus received in a storage section 32, and (iii) communicates the contents to the user terminal 40 such as a smartphone. This allows the user who stays outdoors to know, via the user terminal 40, that it time to replace the urine sheet 14. It is therefore possible for the user to go indoors and replace the urine sheet 14.

The control device 20A in accordance with Embodiment 1 thus controls the pet toilet 1A, which is, for example, a toilet that is an electronic device. The control device 20A includes: the weight obtaining section 21 which obtains information on the weight of the urine sheet 14 which is a consumable item that absorbs urine which is excreta; and the notification processing section 23A which causes the user to be notified of information on time to replace the urine sheet 14, depending on the weight of the urine sheet 14.

According to Embodiment 1, the control device 20A controls an electronic device. The pet toilet 1A, which is a toilet, corresponds to the electronic device.

By the way, conventionally, in a case where the user is notified of information on time to replace a consumable item, a determination has been made on the basis of time of use of the consumable item. However, in a case where the consumable item is, for example, the urine sheet 14, whether or not the pet has urinated, a frequency of urination, and an amount of urine affect the time to replace the consumable item. Accordingly, even in a case where a determination on the time to replace the consumable item is made on the basis of the time of use of the consumable item, appropriate time to replace the consumable item is not always obtained. That is, there is a case where, depending on a type of the consumable item, it is not possible to equally determine the time to replace the consumable item, on the basis of the time of use of the consumable item.

In view of the above, according to Embodiment 1, the control device 20A included in the pet toilet 1A includes the weight obtaining section 21 and the notification processing section 23A. The weight obtaining section 21 obtains the information on the weight of the urine sheet 14 which absorbs urine that is excreta, and the notification processing section 23A causes the user to be notified of the information on the time to replace the urine sheet 14, depending on the weight of the urine sheet 14.

As a result, according to Embodiment 1, the user is notified of the time to replace the urine sheet 14, depending on the weight of the urine sheet 14. Therefore, in a case where the consumable item is, for example, the urine sheet 14, it is possible to appropriately determine whether or not it is time to replace the urine sheet 14, by measuring the weight of urine. Thus, it is possible to provide the control device 20A which allows the user to be notified of the time to replace the consumable item, depending on a weight of the consumable item.

Moreover, the control device 20A in accordance with Embodiment 1 includes the determining section 22 which determines whether or not the weight of the urine sheet 14 is greater than the threshold which is a given value, and in a case where the weight of the urine sheet 14 is greater than the threshold, the notification processing section 23A causes the user to be notified of the information on the time to replace the urine sheet 14.

The control device 20A includes the determining section 22 which determines whether or not the weight of the urine sheet 14 is greater than the threshold. Therefore, by setting the threshold to a weight value indicative of the time to replace the urine sheet 14, it is possible for the determining section 22 to determine whether or not it is time to replace the urine sheet 14. Then, in a case where the determining section 22 determines that it is time to replace the urine sheet 14, the notification processing section 23A causes the user to be notified of the information on the time to replace the urine sheet 14. As a result, it is possible to provide the control device 20A which absolutely allows the user to be notified of the time to replace the urine sheet 14, depending on the weight of the urine sheet 14.

Further, according to the control device 20A in accordance with Embodiment 1, the notification processing section 23A causes the user to be notified of information which recommends replacing the urine sheet 14. This allows the user to know that it is better to replace the urine sheet 14. Note, here, that the notification processing section 23A causes the user to be notified of the information which recommends replacing the urine sheet 14, by, for example, causing the display section 5, which is included in the pet toilet 1A itself and which has, for example, an LED or a display screen, to carry out display or causing the speaker 6, which is included in the pet toilet 1A itself, to ring a buzzer. Alternatively, the notification processing section 23A can cause the user to be notified of the information via communication with the server group 30 or the user terminal 40 each of which is an external device.

Further, according to the control device 20A in accordance with Embodiment 1, the consumable item is the urine sheet 14 which absorbs urine. Therefore, in a case where the consumable item is the urine sheet 14 which absorbs urine, it is possible to provide the control device 20A which allows the user to be notified of the time to replace the urine sheet 14, depending on the weight of the urine sheet 14.

The pet toilet 1A in accordance with Embodiment 1, which is a toilet, includes the control device 20A and the excreta weight scale 3 which is a weight scale and which measures the weight of the urine sheet 14. This makes it possible to provide the pet toilet 1A which includes the control device 20A that allows the user to be notified of the time to replace the urine sheet 14, depending on the weight of the urine sheet 14, by the excreta weight scale 3 measuring the weight of the urine sheet 14.

A control method in accordance with Embodiment 1 is a method of controlling the pet toilet 1A which is an electronic device, the method including: a weight obtaining step of obtaining information on the weight of the urine sheet 14 which absorbs urine; and a notification processing step of causing the user to be notified of information on time to replace the urine sheet 14, depending on the weight of the urine sheet 14. This makes it possible to provide the method of controlling the pet toilet 1A which allows the user to be notified of the time to replace the urine sheet 14, depending on the weight of the urine sheet 14.

### Embodiment 2

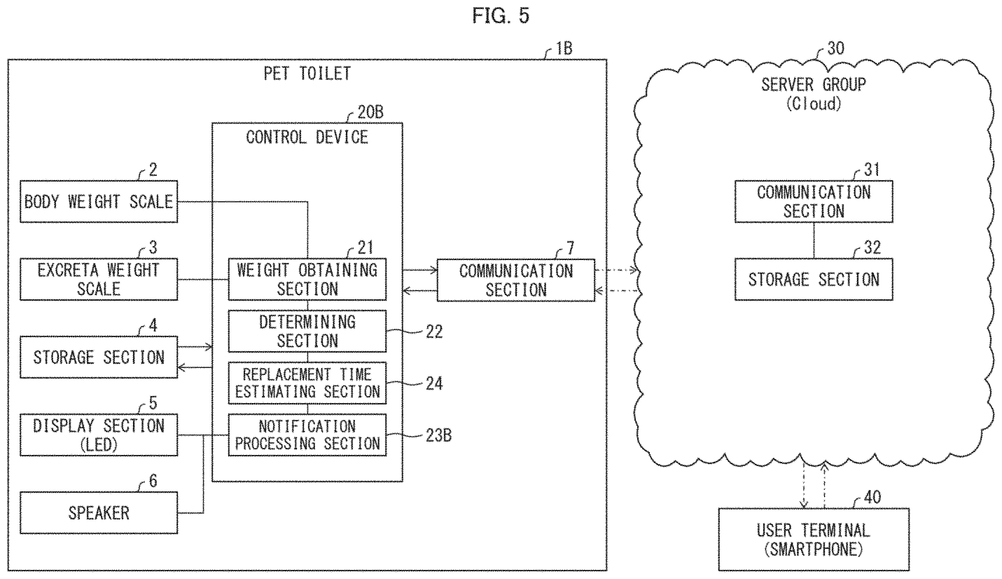

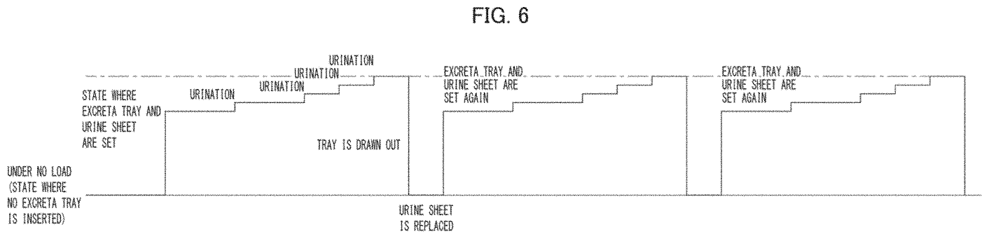

The following description will discuss Embodiment 2 of the present invention with reference to FIGS. 5 and 6. Note that a configuration other than that described in Embodiment 2 is identical to that described in Embodiment 1. Note also that, for convenience, an identical reference numeral will be given to a member having a function identical to that of a member illustrated in the drawings of Embodiment 1, and description of the member will be omitted.

A control device 20B of a pet toilet 1B in accordance with Embodiment 2 is different from the control device 20A of the pet toilet 1A in accordance with Embodiment 1 in that, in addition to the configuration of the control device 20A, the pet toilet 1B includes a replacement time estimating section 24.

A configuration of the control device 20B of the pet toilet 1B in accordance with Embodiment 2 will be described with reference to FIGS. 5 and 6. FIG. 5 is a block diagram illustrating a configuration of the pet toilet 1B and a configuration of the control device 20B in accordance with Embodiment 2. FIG. 6 is a graph showing how, in the pet toilet 1B, time at which it becomes necessary to replace a urine sheet 14 is estimated on the basis of (i) a change in weight of the urine sheet 14 in the past and (ii) the latest weight of the urine sheet 14. In FIG. 6, a horizontal axis indicates time, and a vertical axis indicates a value measured by an excreta weight scale 3 (which value includes a weight of an excreta tray 13 and a weight of the urine sheet 14).

As illustrated in FIG. 5, the control device 20B of the pet toilet 1B in accordance with Embodiment 2 includes a weight obtaining section 21, a determining section 22, the replacement time estimating section 24, and a notification processing section 23B.

The replacement time estimating section 24 estimates time at which it becomes necessary to replace the urine sheet 14, on the basis of (i) a change in weight of the urine sheet 14 in the past and (ii) the latest weight of the urine sheet 14. The replacement time estimating section 24 outputs an estimated time to the notification processing section 23B.

According to Embodiment 2, the notification processing section 23B then causes a user to be notified of information on the time at which it becomes necessary to replace the urine sheet 14.

Specifically, as illustrated in FIG. 6, it is assumed that, in a case where (i) the urine sheet 14 has an excellent urine-absorbing ability and (ii) for example, a pet urinates four times with respect to the urine sheet 14, it becomes necessary to replace the urine sheet 14. Provided that such information on replacement of the urine sheet 14 in the past can be ascertained, an approximate amount of urine per urination can be found out. Furthermore, an increase in weight per time period can be found out.

In view of the above, according to Embodiment 2, for example, in a case where the pet urinates for the first time with respect to the urine sheet 14, the notification processing section 23B causes the user to be notified of a fact that the pet can urinates three more times with respect to the urine sheet 14 that is being used. Furthermore, the notification processing section 23B causes the user to be notified of a time period before it becomes necessary to replace the urine sheet 14 (time at which it becomes necessary to replace the urine sheet 14). Such a notification can be sent to the user via a display section 5 or a speaker 6 of the pet toilet 1B or can be alternatively send to a user terminal 40 via a communication section 7 and a server group 30.

This allows the user to efficiently prepare for replacement of the urine sheet 14. For example, it is possible to predict time to replace the urine sheet 14 and prepare a new the urine sheet 14.

In this manner, the control device 20B of the pet toilet 1B in accordance with Embodiment 2 includes the replacement time estimating section 24 which estimates time at which it becomes necessary to replace the urine sheet 14, on the basis of (i) a change in weight of the urine sheet 14 in the past and (ii) the latest weight of the urine sheet 14, and the notification processing section 23B causes the user to be notified of information on the time at which it becomes necessary to replace the urine sheet 14.

For example, in a case where a consumable item is the urine sheet 14, time to replace the urine sheet 14 comes when the pet has urinated a few times, depending on the urine-absorbing ability of the urine sheet 14. In such a case, according to the control device 20B in accordance with Embodiment 2, the replacement time estimating section 24 estimates time at which it becomes necessary to replace the urine sheet 14, on the basis of (i) a change in weight of the urine sheet 14 in the past and (ii) the latest weight of the urine sheet 14. The notification processing section 23B then causes the user to be notified of information on the time at which it becomes necessary to replace the urine sheet 14, the time having been estimated by the replacement time estimating section 24.

As a result, in a case where time to replace the urine sheet 14 is determined on the basis of a plurality of times of urination, it is possible to appropriately notify the user of the time to replace the urine sheet 14. Furthermore, since contents of a notification is information on time at which it becomes necessary to replace a consumable item, the user can know how many times of urination to be left before time to replace the urine sheet 14 comes. Therefore, it is possible to appropriately prepare a new urine sheet 14.

Note that the notification processing section 23B can cause the user to be notified of the time at which it becomes necessary to replace the urine sheet 14, in a case where the weight of the urine sheet 14 becomes greater than a given threshold. For example, in a case where the weight of the urine sheet 14 is equal to or less than the threshold, the notification processing section 23B does not need to cause the user to be notified of the time at which it becomes necessary to replace the urine sheet 14. Note also that, for example, the notification processing section 23B can (i) cause the user to be notified of the time at which it becomes necessary to replace the urine sheet 14, in a case where the weight of the urine sheet 14 becomes greater than a first threshold, and (ii) cause the user to be notified of (a) the time at which it becomes necessary to replace the urine sheet 14 and (b) a fact that it is necessary to replace the urine sheet 14, in a case where the weight of the urine sheet 14 becomes greater than a second threshold which is greater than the first threshold.

Note that the control device 20B can determine that the excreta tray 13 is drawn out from and then inserted into a main container 11, in a case where the value measured by the excreta weight scale 3 is decreased by a given value or more and then increased by the given value or more. In a case where the value measured after the excreta tray 13 is inserted is lower than that measured before the excreta tray 13 is drawn out, the control device 20B can determine that the urine sheet 14 has been replaced. The given value can be set to, for example, a value corresponding to a weight of the excreta tray 13. Those matters hold true for the other embodiments.

### Embodiment 3

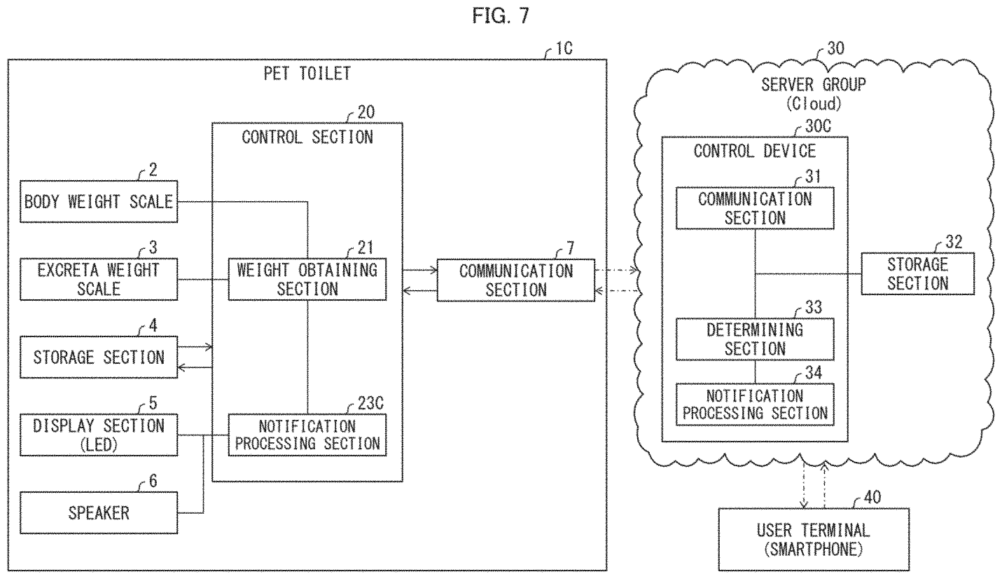

The following description will discuss Embodiment 3 of the present invention with reference to FIG. 7. Note that a configuration other than that described in Embodiment 3 is identical to those described in Embodiments 1 and Embodiment 2. Note also that, for convenience, an identical reference numeral will be given to a member having a function identical to that of a member illustrated in the drawings of Embodiments 1 and 2, and description of the member will be omitted.

The control device 20A of the pet toilet 1A in accordance with Embodiment 1 and the control device 20B of the pet toilet 1B in accordance with Embodiment 2 are provided to the pet toilet 1A and the pet toilet 1B, respectively. A pet toilet 1C in accordance with Embodiment 3 is different from the pet toilet 1A and the pet toilet 1B in that, according to the pet toilet 1C, a control device 30C is provided to a server group 30.

The control device 30C of the pet toilet 1C in accordance with Embodiment 3 will be described with reference to FIG. 7. FIG. 7 is a block diagram illustrating a configuration of the control device 30C of the pet toilet 1C in accordance with Embodiment 3.

As illustrated in FIG. 7, according to the pet toilet 1C in accordance with Embodiment 3, a control section 20 is provided as a control system of the pet toilet 1C, and the control section 20 includes a weight obtaining section 21 and a notification processing section 23C.

A value measured by an excreta weight scale 3 is inputted into the weight obtaining section 21. The weight obtaining section 21 obtains a weight of a urine sheet 14, and immediately transmits the weight thus obtained to the server group 30 via a communication section 7. Note that the weight obtaining section 21 can transmit, to the server group 30, the value measured by the excreta weight scale 3 or can alternatively transmit, to the server group 30, a value obtained by subtracting, for example, a weight of the excreta tray 13 from such a measured value.

The notification processing section 23C provided to the control section 20 receives information on replacement of the urine sheet 14, which information has been transmitted from a notification processing section 34 (later described) of the control device 30C of the server group 30 via a communication section 31 and the communication section 7, and then causes a display section 5 and a speaker 6 to notify a user of the information.

According to Embodiment 3, the control device 30C is provided to the server group 30. That is, according to Embodiment 3, the control device 30C of the server group 30 receives merely information on a weight of urine from the control system of the pet toilet 1C, and determines whether or not it is time to replace the urine sheet 14. In a case where it is time to replace the urine sheet 14, the control device 30C of the server group 30 causes a user terminal 40 and the pet toilet 1C to notify the user of information on time to replace the urine sheet 14.

As a configuration for this, the server group 30 (information processing device) includes the control device 30C and a storage section 32. The server group 30 includes, in an information processing device (not illustrated), the control device 30C which includes the communication section 31 (weight obtaining section), a determining section 33, and the notification processing section 34.

According to Embodiment 3, the control device 30C is configured such that the communication section 31 receives information on the weight of the urine sheet 14, which information has been obtained by the weight obtaining section 21, from the communication section 7 of the pet toilet 1C. The control device 30C then stores the information on the weight in the storage section 32.

Next, the determining section 33 of the control device 30C determines whether or not the weight of the urine sheet 14 is greater than a threshold which is a set given value.

In a case where the weight of the urine sheet 14 is greater than the threshold which is a set given value, it is time to replace the urine sheet 14. Therefore, the notification processing section 34 of the control device 30C causes, via the communication section 31, the user terminal 40 and the notification processing section 23C of the pet toilet 1C to cause a user to be notified of information on time to replace the urine sheet 14.

This allows the user to know, on the user terminal 40 such as a smartphone, that it is time to replace the urine sheet 14. Furthermore, since, also in the pet toilet 1C itself, the display section 5 and the like indicate that it is time to replace the urine sheet 14, the user can know, by such indication, that it is time to replace the urine sheet 14.

Note that an aspect of the present invention is not limited to Embodiment 3, and can be altered within the scope of the present invention. For example, according to Embodiment 3, the control device 30C is provided to the information processing device of the server group 30. However, an aspect of the present invention is not particularly limited to such a configuration, and, for example, the control device 30C can be provided to the user terminal 40 which is an information processing device.

That is, a control device can be provided to the pet toilet 1A, 1B itself as in Embodiments 1 and 2 or can be alternatively provided to the server group 30 or the user terminal 40, which are different from the pet toilet 1A, 1B itself and which is provided outside the pet toilet 1A, 1B, as in Embodiment 3.

As such, the control device 30C in accordance with Embodiment 3 thus controls the server group 30 or the user terminal 40, each of which is an electronic device. The control device 30C includes: the communication section 31 serving as a weight obtaining section which obtains information on the weight of the urine sheet 14 that absorbs urine; and the notification processing section 34 which causes the user to be notified of information on time to replace the urine sheet 14, depending on the weight of the urine sheet 14.

According to the above configuration, the control device 30C controls, for example, the information processing device of the server group 30 or an information processing device such as the user terminal 40, each of the server group 30 and the information processing device such as the user terminal 40 being an electronic device. That is, according to Embodiment 3, in a case where the control device 30C is provided to, for example, the server group 30, the server group 30 including the information processing device corresponds to an electronic device. In a case where the control device 30C is provided to, for example, the user terminal 40 such as a smartphone, the information processing device such as the user terminal 40 corresponds to an electronic device.

According Embodiment 3, the control device 30C includes the communication section 31, which serves as a weight obtaining section, and the notification processing section 34. Therefore, the communication section 31 obtains, via the weight obtaining section 21 of the control section 20 and the communication section 7 which are included in the pet toilet 1C, information on the weight of the urine sheet 14 which absorbs urine, and the notification processing section 34 causes the user to be notified of information on time to replace the urine sheet 14, depending on the weight of the urine sheet 14. Thus, it is possible to provide the control device 30C which allows the user to be notified of time to replace the urine sheet 14, depending on the weight of the urine sheet 14.

The information processing device of the server group 30, which information processing device is an information processing device, and the user terminal 40, which is an information processing device, in accordance with Embodiment 3 includes the control device 30C, and the communication section 31 obtains information on the weight of the urine sheet 14 from the weight obtaining section 21 of the pet toilet 1C via the communication section 7. The user terminal 40 obtains the weight of the urine sheet 14 directly from the pet toilet 1C or via the server group 30.

With this, in a case where the control device 30C is provided to, for example, the information processing device of the server group 30 or the like or the information processing device such as the user terminal 40, it is possible to provide the information processing device which includes the control device 30C that allows the user to be notified of time to replace the urine sheet 14, depending on the weight of the urine sheet 14.

[Software Implementation Example]

A control block (particularly, the weight obtaining section 21, the determining section 22, and the notification processing section 23A) of the control device 20A in accordance with Embodiment 1, a control block (particularly, the weight obtaining section 21, the determining section 22, the replacement time estimating section 24, and the notification processing section 23B) of the control device 20B in accordance with Embodiment 2, and a control block (particularly, the communication section 31, the determining section 33, and the notification processing section 34) of the control device 30C in accordance with Embodiment 3 can be implemented by a logic circuit (hardware) provided on, for example, an integrated circuit (IC chip) or can be alternatively implemented by software.

In the latter case, each of the control devices 20A, 20B, and 30C includes a computer which executes instructions of a program that is software realizing the foregoing functions. The computer includes, for example, at least one processor (control device) and at least one computer-readable storage medium which stores therein the program. By, in the computer, the at least one processor reading the program from the storage medium and executing the program, the object of an aspect of the present invention is attained. Examples of the at least one processor include central processing units (CPUs). Examples of the storage medium include “non-transitory tangible mediums” such as a tape, a disk, a card, semiconductor memory, and a programmable logic circuit, as well as a read only memory (ROM). The computer can further include a random access memory (RAM) or the like in which the program is loaded. The program can be supplied to or made available to the computer via any transmission medium (such as a communication network or a broadcast wave) which allows the program to be transmitted. Note that an aspect of the present invention can also be attained in the form of a computer data signal in which the program is embodied via electronic transmission and which is embedded in a carrier wave.

A control program in accordance with an embodiment of the present invention is a control program for causing a computer to function as each of the control devices 20A, 20B, and 30C, the control program causing the computer to function as the weight obtaining section 21, the determining section 22, the notification processing section 23A, the replacement time estimating section 24, the notification processing section 2313, the determining section 33, and the notification processing section 34.

That is, the control device 20A in accordance with Embodiment 1, the control device 20B in accordance with Embodiment 2, and the control device 30C in accordance with Embodiment 3 can be realized by a computer. In this case, the scope of an aspect of the present invention also encompasses (i) a control program for an electronic device, the control program causing a computer to realize the electronic device by causing the computer to function as each section (software element) included in the electronic device and (ii) a computer-readable storage medium in which the control program is stored.

[Recap]

A control device in accordance with a first aspect of the present invention is a control device which controls an electronic device, the control device including: a weight obtaining section which obtains information on a weight of a consumable item which absorbs excreta; and a notification processing section which causes a user to be notified of information on time to replace the consumable item, depending on the weight of the consumable item.

The control device in accordance with a second aspect of the present invention can be arranged so as to further include a determining section which determines whether or not the weight of the consumable item is greater than a given value, in a case where the weight of the consumable item is greater than the given value, the notification processing section causing the user to be notified of the information on the time to replace the consumable item.

The control device in accordance with a third aspect of the present invention can be arranged such that the notification processing section causes the user to be notified of information which recommends replacing the consumable item.

The control device in accordance with a fourth aspect of the present invention can be arranged so as to further include a replacement time estimating section which estimates time at which it becomes necessary to replace the consumable item, on the basis of (i) a change in weight of the consumable item in the past and (ii) the latest weight of the consumable item, the notification processing section causing the user to be notified of information on the time at which it becomes necessary to replace the consumable item.

The control device in accordance with a fifth aspect of the present invention can be arranged such that the consumable item is a sheet which absorbs urine.

A toilet in accordance with a sixth aspect of the present invention is a toilet including: the above-described control device; and a weight scale which measures the weight of the consumable item.

An information processing device in accordance with a seventh aspect of the present invention is an information processing device including the above-described control device, the weight obtaining section obtaining, from a toilet, the information on the weight of the consumable item.

A control program in accordance with an eighth aspect of the present invention is a control program for causing a computer to function as the above-described control device, the control program causing the computer to function as the weight obtaining section and the notification processing section.

A control process in accordance with a ninth aspect of the present invention is a method for controlling an electronic device, the method including: a weight obtaining step of obtaining information on a weight of a consumable item which absorbs excreta; and a notification processing step of causing a user to be notified of information on time to replace the consumable item, depending on the weight of the consumable item.

Note that the present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1A through 1C pet toilet (toilet)

2 Body weight scale

3 Excreta weight scale

4 Storage section

5 Display section

6 Speaker

7 Communication section

11 Main container

11a Opening

11b Side hole

12 Measurement stage

12a Opening

12b Mesh

13 Excreta tray

13a Bottom plate

14 Urine sheet (consumable item)

15 Supporting plate

20A Control device

21 Weight obtaining section

22 Determining section

23 Notification processing section

30 Server group

31 Communication section (weight obtaining section)

32 Storage section

33 Determining section

34 Notification processing section

40 User terminal (information processing device)

1. A control device which controls an electronic device, the control device comprising:
a weight obtaining section which obtains information on a weight of a consumable item which absorbs excreta; and
a notification processing section which causes a user to be notified of information on time to replace the consumable item, depending on the weight of the consumable item.

2. The control device as set forth in claim 1, further comprising
a determining section which determines whether or not the weight of the consumable item is greater than a given value,
in a case where the weight of the consumable item is greater than the given value, the notification processing section causing the user to be notified of the information on the time to replace the consumable item.

3. The control device as set forth in claim 2, wherein the notification processing section causes the user to be notified of information which recommends replacing the consumable item.

4. The control device as set forth in claim 1, further comprising
a replacement time estimating section which estimates time at which it becomes necessary to replace the consumable item, on the basis of (i) a change in weight of the consumable item in the past and (ii) the latest weight of the consumable item,
the notification processing section causing the user to be notified of information on the time at which it becomes necessary to replace the consumable item.

5. The control device as set forth in claim 1, wherein the consumable item is a sheet which absorbs urine.

6. A toilet comprising:
a control device recited in claim 1; and
a weight scale which measures the weight of the consumable item.

7. An information processing device comprising
a control device recited in claim 1,
the weight obtaining section obtaining, from a toilet, the information on the weight of the consumable item.

8. A non-transitory computer-readable storage medium which stores therein a control program for causing computer to function as a control device recited in claim 1,
the control program causing the computer to function as the weight obtaining section and the notification processing section.

9. A method for controlling an electronic device, the method comprising:
a weight obtaining step of obtaining information on a weight of a consumable item which absorbs excreta; and
a notification processing step of causing a user to be notified of information on time to replace the consumable item, depending on the weight of the consumable item.
